(19) United States
(12) Patent Application Publication
(10) Pub. No.: US 2015/0030968 A1
(43) Pub. Date: Jan. 29, 2015

(54) AEROGEL BASED ON DOPED GRAPHENE

(71) Applicants: BASF SE, Ludwigshafen (DE); Max-Planck-Gesellschaft zur Foerderung der Wissenschaften e.V., Muenchen (DE)

(72) Inventors: Matthias Georg Schwab, Mannheim (DE); Klaus Muellen, Koeln (DE); Xinliang Feng, Mainz (DE); Zhong-Shuai Wu, Mainz Bretzenheim (DE)

(73) Assignees: BASF SE, Ludwigshafen (DE); Max-Planck-Gesellschaft zur Foerderung der Wissenschaften e.V., Muenchen (DE)

(21) Appl. No.: 14/384,095

(22) PCT Filed: Feb. 26, 2013
(86) PCT No.: PCT/IB13/51542

§ 371 Date: Sep. 9, 2014

Related U.S. Application Data
(60) Provisional application No. 61/608,721, filed on Mar. 9, 2012.
(60) Provisional application No. 61/650,493, filed on May 23, 2012.

(51) Int. Cl. H01G 11/24; H01M 4/96; H01M 4/90; H01G 11/32; H01G 11/56

(52) U.S. Cl. CPC H01G 11/24; H01G 11/32; H01G 11/56; H01M 4/90; H01M 4/96
USPC 429/532; 361/502; 502/180; 502/182; 502/185; 502/184

(57) ABSTRACT

The present invention relates to an aerogel based on doped graphene, a method for producing said aerogel and the use of said aerogel, for example, as an electrode or a catalyst. Furthermore, the present invention relates to electrodes, all solid-state supercapacitors (ASSS) or catalysts based on said aerogel. The present invention also relates to doped graphene, which can be obtained as an intermediate in the production of the aerogel based on doped graphene using graphene oxide as starting material.

The present invention relates to an aerogel based on doped graphene, a method for producing said aerogel and the use of said aerogel, for example, as an electrode or a catalyst. Furthermore, the present invention relates to electrodes, all solid-state supercapacitors (ASSS) or catalysts based on said aerogel. The present invention also relates to doped graphene, which can be obtained as an intermediate in the production of the aerogel based on doped graphene using graphene oxide as starting material.

Supercapacitors, also called ultracapacitors or electrochemical capacitors, are one important energy storage device that deliver with orders of magnitude higher power density achieved in seconds, cycle efficiency, rates of charge and discharge, and longer cycling life than traditional batteries. Carbon-based electrochemical double layer capacitors have attracted intensive attentions because they can provide ultrahigh power density and excellent cycle life. Due to the high surface area, electrical conductivity, and nanostructures carbons of carbon nanotubes, porous carbon, carbide-derived carbons as well as graphene are widely explored as electrode materials for supercapacitors.

The European application PCT/IP2011055282 relates to a process for manufacturing a nitrogen-containing porous carbonaceous material with an optional inorganic salt content, wherein in a first reaction step at least one heterocyclic hydrocarbon with at least two NH₂-groups is reacted with at least one aromatic compound with at least two aldehyde groups. In a second reaction step the reaction procuct of step (a) is heated in the absence of oxygen to temperatures in the range from 700 to 1200° C. Said carbonaceous material can be used in capacitors or as an catalyst. Used as capacitors, the respective electrodes comprise besides said carbonaceous material also at least one binder and optionally at least one additive.

US-A 2010/0144904 discloses a carbon-based aerogel, in which the carbon atoms are arranged in a sheet-like nanostructure. The aerogel may be either a graphene oxide aerogel or a graphene aerogel and may further be reinforced with a polymer. The graphene aerogel is obtained from the respective graphene oxide aerogel by reducing the water-dispersed graphene oxide to graphene, followed by a freeze-drying step. The graphene aerogels are described as highly porous and can be used as electrically conductive electrode materials for energy storage and energy conversion applications, such as electrochemical double-layer capacitors. However, nowhere within US-A 2010/0144904 it is disclosed that those graphene-based aerogels can be doped with a heteroatom such as nitrogen or boron.

X. Zhang et al. (Journal of Materials Chemistry; published on 1 Apr. 2011, 4 pages) discloses mechanically strong and electrically conductive graphene aerogels, which can be prepared by either supercritical drying or freeze-drying of hydrogel precursors synthesized from reduction of graphene oxide with L-ascorbic acid. It is described therein that it is an advantage to choose L-ascorbic acid as reducing agent instead of conventional reducing agents such as hydrogen, NaBH₄ or LiAlH₄, since no gaseous products are formed during the formation of the gel precursor.

W. Chen et al. (Advanced Materials, 2011, 23, pages 5679-5683) discloses the self-assembly and embedding of nanoparticles in order to obtain a threedimensional (3D) graphene-nanoparticle aerogel. The nanoparticles employed contain Fe, in particular the nanoparticles are Fe₃O₄. Said graphene-based aerogel embedded with Fe-containing nanoparticles can be employed as electrode material in electrochemical processes. However, nowhere within said article it is disclosed that a graphene-based aerogel may be doped with heteroatoms such as nitrogen or boron.

Therefore, the object of the present invention is to provide a new material, which can be successfully employed, for example, in the field of capacitors or catalysts. The object is achieved by an aerogel based on graphene doped with nitrogen and boron.

A major advantage of the aerogel according to the present invention is that it can directly serve as additive and/or binder-free electrodes. The aerogel according to the present invention shows a better performance compared to inventional materials such as aerogel based on graphene, which does not contain dopants (undoped graphene aerogel). Furthermore, the aerogel according to the present invention has a better performance than aerogel based on graphene, which is only doped with nitrogen or only doped with boron.

It is a further advantage of the present invention that the aerogel or electrode made thereof can easily be embedded with an electrolyte such as PVAH₂SO₄-gel. Due to this embedment, aerogel electrodes can be produced, wherein the respective electrolytegel serves as solid electrolyte and separator.

By consequence, the aerogels according to the present invention show a threedimensional (3D) open macroporosity with interconnected network structure, high specific surface area, excellent electrical conductivity, mechanically flexibility and/or light weight. These features render the fully interfacial wettability of electrolyte for rapid ion diffusion in the bulk electrode and fast electron transport in the 3D graphene network.

By consequence, the resulting all solid state supercapacitors (ASSSs) based on aerogels according to the present invention show high specific capacitance, good rate capability, enhanced energy density or power density in comparison with undoped graphene aerogels (GAs), only N- or B-doped GAs, and layer-structured graphene paper (GP).

It is also advantageous that the aerogel according to the present invention can be produced in an easy way, for example by a hydrothermal assembly of an aqueous solution of graphene oxide containing flake sizes ranging between hundreds of nanometers and several micrometers followed by freeze-drying. The volume and shape of the aerogel, for example as aerogel monoliths, can be well controlled by the concentration of graphene oxide, the time or the temperature of hydrothermal treatment or additionally by the shape of the vial used.

Subsequently, the present invention is explained in more detail.

The first subject of the present invention is an aerogel based on graphene doped with nitrogen and boron.

Within the context of the present invention the term “doped with” relates to the boron and nitrogen atoms, which are incorporated into the graphene lattice, preferably by forming (chemical) bonds between boron or nitrogen with the carbon atoms of the graphene lattice. However, it is also possible that individual boron atoms are directly bonded to individual nitrogen atoms within said graphene lattice. Preferably, all or nearly all of the nitrogen and/or boron atoms provided via the respective educts (see below) during the inventive method for producing said aerogels are doped onto the graphene by being incorporated into the graphene lattice. However, it is also possible that smaller amounts of nitrogen and/or boron atoms provided via the respective educts are only chemically or physically adsorbed on the surface of the graphene. If so, the respective nitrogen and/or boron atoms are usually present in form of the respective educt employed or as an intermediate. Usually, the amount of said chemically or physically adsorbed nitrogen and/or boron is less than 10% of the amount of nitrogen and/or boron being doped onto graphene in the context of the present invention.

The aerogel according to the present invention contains nitrogen and boron, which are doped on graphene, in any suitable amounts, which are known to the person skilled in the art. Usually, the aerogel contains 0.1 to 6 wt.-%, preferably 2.5 to 3.5 wt.-% of nitrogen and/or 0.1 to 2 wt.-%, preferably 0.3 to 0.9 wt.-% of boron. More preferably, the aerogel according to the present invention contains 3.0 wt.-% of nitrogen and/or 6 wt.-% of boron. The before-mentioned ranges and numbers expressed in wt.-% relate to the total weight of the aerogel, preferably in a solid state. Any optionally present solvents, electrolytes and/or metals, such as Fe or Co, are not considered within the before-mentioned weight ranges or numbers.

The aerogel according to the present invention is preferably a threedimensional (3D) aerogel, which is monolithic. This means that the aerogel according to the present invention is preferably based on graphene doped with nitrogen and boron, wherein ultrathin walls of graphene nanosheets are interconnected to build up a 3D-framework. Furthermore, the aerogel according to the present invention has a macroporous structure, more preferably a highly macroporous structure. The size of macropores is ranging from 200 nm to tens of micrometers.

The aerogel according to the present invention has preferably at least one parameter selected from a surface area ranging from 200 to 1000 m²/g, an electrical conductivity of 0.1×10⁻³ to 1 S/cm, a light weight with mass densitiy of 20 to 50 mg/cm³, a compressive strength of 0.02 to 0.08 and/or a compress modulus of 0.1 to 0.5 MPa. More preferably, the aerogel according to the present invention fulfills each of the before-listed parameters.

In one embodiment of the present invention the aerogel further contains Fe and/or Co and optionally at least one metal selected from Pt, Mn, Ni, V, Cr, Ti, Pd, Ru, Se or Cu. Said metals, in particular Pt, may be present in form of alloys, for example as Pt alloys, which are known to a skilled person. Preferred alloys comprise at least one metal from the platinum group (of the periodic table of elements). Preferably said alloys are selected from the group consisting of PtNi, PtFe, PtV, PtCr, PtTi, PtCu, PtPd, PtRu, PdNi, PdFe, PdCr, PdTi, PdCu and PdRu. Further details in respect of the educts or the oxidation number of the before listed metals such as Fe, Co, Ni or Pt are described below in connection with the process for producing aerogels according to the present invention. More preferably, the aerogel further contains Fe and Co. The amount of metals ranges from 0.01 to 30 wt.-% in the aerogel. Aerogels according to this embodiment are preferably employed as catalysts or as an intermediate for producing a catalyst.

Preferably, Fe is employed as Fe₂O₃ or Fe₃O₄, and/or Co is employed as Co, Co(OH)₂, Co₃O₄ or CoO. More preferably, Fe, Co and/or any optionally present metal are employed as small particles, preferably as nanoparticles.

In another embodiment of the present invention the aerogel further contains at least one metal selected from Pt, Mn, Ni, V, Cr, Ti, Pd, Ru, Se or Cu and optionally contains Fe and/or Co. Within said embodiment metals such as Pt may be present in form of alloys or the optional component Fe may be employed as Fe₂O₃ or Fe₃O₄. This means that said metals may be present within said embodiment analogously as disclosed for the previous embodiment, wherein Fe and/or Co are mandatory components.

Another subject of the present invention is a method for producing the above described aerogels. Methods as such for producing aerogels are known to a person skilled in the art. The aerogels according to the present invention are preferably produced by a method, wherein

i) graphene oxide is treated with at least one component (A) containing nitrogen and at least one component (B) containing boron and/or

ii) graphene oxide is treated with at least component (C) containing both nitrogen and boron

in order to obtain graphene doped with nitrogen and boron.

Graphene oxide as such, employed as a starting material within the process according to the present invention, is known to a person skilled in the art. Preferably, graphene oxide is employed as a dispersion, more preferably as an aqueous dispersion. Graphene oxide is preferably obtained from graphite. Preferably, graphene oxide is obtained by a process, wherein graphite, preferably graphite flakes, is oxidized into graphite oxide, which in turn is delaminated into graphene oxide. It is preferred to employ graphene oxide flakes, preferably an aqueous dispersion of graphene oxide flakes, wherein the flakes are in the range of hundreds of nanometers to several micrometers.

Within said method the components (A) and/or (C) are employed as doping agents (dopants or co-dopants) in order to obtain the nitrogen part of the doping of the graphene. Analogously, the component (B) and/or component (C) are employed for obtaining the boron part of the doping of graphene.

The components (A) to (C) are known to persons skilled in the art. Preferably, the component (A) is cyandiamide (CH₂N₂), dicyandiamide (C₂H₄N₄) or ethylenediamine (C₂H₈N₂), the component (B) is boric acid (H₃BO₃) and/or the component (C) is NH₃BF₃ or NH₃BH₃. Most preferably, the method for producing the aerogel according to the present invention is carried out with only employing one compound of component (C), which preferably is NH₃BF₃.

Within this method for producing an aerogel according to the present invention, graphene doped with nitrogen and boron is obtained as an intermediate. The graphene doped with nitrogen and boron as such (the intermediate) is described below in more detail. The graphene doped with nitrogen and boron as such can be isolated within the method for producing an aerogel according to the present invention. However, said doped graphene is obtained in situ within said method for producing an aerogel and there is no need for mandatorily isolating said doped graphene when producing the aerogel using graphene oxide as starting material (educt).

The method for producing an aerogel according to the present invention may comprise further steps. Preferably, the treatment of graphene oxide further comprises a hydrothermal step and/or a drying step, preferably a freeze drying step. In case a hydrothermal step is performed, said hydrothermal step can be performed in parallel or, preferably, after the starting material graphene oxide is treated with the components (A) to (C). The hydrothermal step is preferably carried out with an aqueous dispersion of graphene oxide at temperatures in the range of 100 to 200° C. and/or for a time range of 2 to 24 hours. In carrying out a hydrothermal step, usually a hydrogel is obtained as an intermediate prior to obtaining an aerogel according to the present invention.

It is also preferred to carry out a drying step according to the method for producing an aerogel according to the present invention. A drying step is preferably carried out, in case graphene oxide is employed as a dispersion, preferably as an aqueous dispersion. Drying steps as such are known to persons skilled in the art. Preferably, the drying step is carried out as a freeze drying step. Most preferably, a hydrothermal step is carried out followed by a freeze drying step. This can be performed with or without isolation of any optionally formed intermediate (such as hydrogel).

The respective educts, compounds, solvents etc. employed within the process according to the present invention can be employed in amounts/ranges known to a person skilled in the art. For example, the required amount of component (C) can be easily determined by a person skilled in the art in order to arrive at the respective weight-%-ranges for nitrogen and boron as described before in connection with the aerogel as such.

In another embodiment of the present invention an aerogel is produced, wherein the aerogel further contains Fe and/or Co and optionally at least one metal selected from Pt, Mn, Ni, V, Cr, Ti, Pd, Ru, Se or Cu. The respective metals may be added at the same time, prior or later than the time, at which graphene oxide is treated with the components (A) to (C). In a further embodiment of the present invention an aerogel is produced, wherein the aerogel further contains at least one metal selected from Pt, Mn, Ni, V, Cr, Ti, Pd, Ru, Se or Cu and optionally contains Fe and/or Co.

Methods for producing aerogels containing metals, such as Fe or Co, are known to a skilled person. The metals can be employed, for example, in pure form (alloys or metals as such having an oxidation number of +/−0) or they can be employed as a salt or oxide, for example as Fe₂O₃ as described above in connection with the aerogel as such. In case the respective metals are employed as alloys, it is referred to WO 2010/026046 or WO 2011/095943, wherein alloys as such and methods for producing alloys are described, which can be employed within the context of the present invention.

In case an aerogel according to the present invention is produced additionally containing Fe, Co and/or optionally a further metal, the thermal treatment, preferably the hydrothermal step, is carried out under nitrogen or argon gas atmosphere and/or at a temperature in the range of 500 to 1000° C. The same holds true for the further embodiment containing Fe and/or Co only as an optional component.

Another subject of the present invention is graphene doped with nitrogen and boron as such, which can be isolated as an intermediate within the production process for the aerogel according to the present invention (as already indicated above). Methods for the isolation of doped graphene oxide are known to a person skilled in the art and can be employed for the graphene doped with nitrogen and boron according to the present invention accordingly.

The graphene doped with nitrogen and boron as such has the same parameters and/or optional components as described above for the doped graphene in connection with the aerogel. For example, graphene doped with nitrogen and boron as such may further contain (in one embodiment) Fe and/or Co and optionally at least one metal selected from Pt, Mn, Ni, V, Cr, Ti, Pd, Ru, Se or Cu. In another embodiment, the graphene doped with nitrogen and boron as such may further contain at least one metal selected from Pt, Mn, Ni, V, Cr, Ti, Pd, Ru, Se or Cu and may optionally contains Fe and/or Co. The graphene doped with nitrogen and boron as such usually contains 0.1 to 6 wt.-%, preferably 2.5 to 3.5 wt.-% of nitrogen and/or 0.1 to 2 wt.-%, preferably 0.3 to 0.9 wt.-% of boron.

Another subject of the present invention is an electrode made from an aerogel based on graphene doped with nitrogen and boron as described above. Accordingly, a method for preparing such an electrode is also a subject-matter of the present invention. Methods for preparing an electrode from an aerogel based on graphene are known to a person skilled in the art.

The electrode according to the present invention preferably comprises further an electrolyte which is preferably a PVAH₂SO₄ gel (a gel made of polyvinyl alcohol and H₂SO₄), a PVAH₃PO₄ gel, a PVAKOH gel, a PVANaOH gel, a PVANa₂SO₄ gel or a ionic liquid polymer gel. The before-mentioned gels are known to a person skilled in the art. Ionic liquid polymer gels as such and methods for producing said ionic liquid polymer gels are described, for example, in S. M. Zakeeruddin and M. Gratzel, Adv. Fund. Mater. (2009), 19, pages 2187-2202, in particular under section 6.

In case a ionic liquid polymer gel is employed within the present invention, it is preferred to employ at least one ionic liquid of the formula 1-alkyl-3-methylimidazolium halide, wherein alkyl is preferably C₃ to C₉-alkyl and/or halide is preferably iodide. As polymer or gelator within said ionic liquid polymer gel it is preferred to employ a low molecular weight polymer (gelator) such as poly(vinylidinefluoride-co-hexafluoropropylene).

More preferably, the electrolyte is a PVAH₂SO₄ gel. It is also preferred that the electrode according to the present invention is obtained by cutting the aerogel into slices having a thickness of 0.5 to 1.5 mm and/or having a diameter of 5 to 15 mm.

Another subject of the present invention are all solid state supercapacitors (ASSSs) containing an aerogel as described above or an electrode as described above.

Another subject of the present invention is a catalyst containing an aerogel as described above. Preferably, the catalyst according to the present invention contains small particles of Fe and Co, preferably nanoparticles of Fe₃O₄ and Co₃O₄.

Within the context of the present invention the aerogels of the present invention may directly be employed as catalyst, they may form parts of a catalyst or they may be employed as an intermediate for producing a catalyst based on said aerogels.

Another subject of the present invention is the use of an aerogel as described above as electrode, preferably as oxygen consumption electrode, in batteries, in supercapacitors, preferably in all solid state supercapacitors, or as catalysts, preferably as electrocatalysts for oxygen reduction reactions. An oxygen consumption electrode is preferably employed in chlorine-alkali-electrolysis.

Another subject of the present invention is the use of graphene doped with nitrogen and boron as described above for producing an aerogel, an electrode, preferably an oxygen consumption electrode, a battery, a supercapacitor, preferably an all solid state supercapacitor, or a catalyst, preferably an electrocatalyst for oxygen reduction reactions. An oxygen consumption electrode is preferably employed in chlorine-alkali-electrolysis.

The present invention is further illustrated by the examples as follows.

### Example 1

(Preparation of Graphite Oxide)

Graphite oxide (GO) is prepared from natural graphite flakes using a modified Hummers method, the details of which are described in the publication: William S. Hummers Jr., Richard E. Offeman, Preparation of Graphitic Oxide, J. Am. Chem. Soc., 1958, 80(6), p. 1339.

### Example 2

(Preparation of Aerogel Based on Graphene Doped With Nitrogen and Boron (BNGA))

Aerogel based on graphene doped with nitrogen and boron (BNGA) is prepared by a combined hydrothermal assembly and freeze-drying method. A 15 mL GO aqueous dispersion (with 1.0 GO per mL of dispersion) containing the amount of 100 mg NH₃BF₃ is firstly treated by sonication for 5 mins, and then the stable suspension sealed in a Telfon-lined autoclave is hydrothermally treated at 180° C. for 12 h. After that, the as-prepared sample is freeze-dried overnight, followed by vacuum drying at 60° C. for several hours. The yield of the as-prepared graphene aerogel is 10 to 20 wt.-% related to the amount of GO as employed.

### Comparative Example 3

(Preparation of An Aerogel Based on Graphene Without Any Dopants (GA)

Graphene aerogel (GA) is prepared by a combined hydrothermal assembly and freeze-drying method. A 10 mL GO aqueous dispersion (with 0.5 to 2.0 mg GO per mL of dispersion) is firstly treated by sonication for 5 mins, and then the stable suspension sealed in a Telfon-lined autoclave is hydrothermally treated at 150° C. for 24 h. After that, the as-prepared sample is freeze-dried overnight, followed by vacuum drying at 60° C. for several hours. The yield of the as-prepared aerogel is 60 to 70 wt.-% related to the amount of GO as employed.

### Comparative Example 4

(Aerogel Based on Graphene Doped With Nitrogen Only (NGA))

Aerogel based on graphene doped with nitrogen (NGA) is prepared by a combined hydrothermal assembly and freeze-drying method. A 10 mL GO aqueous dispersion (with 1.0 mg GO per mL of dispersion) contains the amount of 50 mg dicyandiamide (C₂H₄N₄) is firstly treated by sonication for 5 mins, and then the stable suspension sealed in a Telfon-lined autoclave is hydrothermally treated at 180° C. for 20 h. After that, the as-prepared sample is freeze-dried overnight, followed by vacuum drying at 70° C. for several hours. The yield of the as-prepared aerogel is 15 to 30 wt.-% related to the amount of GO as employed.

### Comparative Example 5

(Aerogel Based on Graphene Doped With Boron Only (BGA))

Aerogel based on graphene doped with boron (BGA) is prepared by a combined hydrothermal assembly and freeze-drying method. A 10 mL GO aqueous dispersion (with 1.0 mg GO per mL of dispersion) contains the amount of 50 mg boric acid (H₃BO₃) is firstly treated by sonication for 5 mins, and then the stable suspension sealed in a Telfon-lined autoclave is hydrothermally treated at 180° C. for 20 h. After that, the as-prepared sample is freeze-dried overnight, followed by vacuum drying at 70° C. for several hours. The yield of the as-prepared aerogel is 15 to 30 wt.-% related to the amount of GO as employed.

### Comparative Example 6

(Layer-Structured Graphene Paper (GP))

GP can be readily fabricated by vacuum filtration of stable black thermally reduced (H₂ flow at 450° C.) graphene supernatant in N-methylpyrolidone with the concentration of 0.05-0.20 mg/m, followed by filtration, washing with water and ethanol. Finally, the as-papered graphene film is air dried and carefully peeled from the filter.

### Example 7

(Characterization)

All of the examples 2 to 6 are characterized by scanning electron microscopy (SEM, Gemini 1530 LEO), high resolution transmission electron microscopy (HRTEM, Philips Tecnai F20), atomic force microscopy (AFM, Veeco Dimension 3100), X-ray photoelectron spectroscopy (XPS, VG ESCA 2000). Nitrogen adsorption and desorption isotherms are measured at 77 K with a Micromeritcs Tristar 3000 analyzer (USA).

GA, NGA, BGA and BNGA monoliths are slightly cut into small slices with a thickness of about 1 mm and a diameter of about 7 to 10 mm, and pressed into a flat thin electrode with a thickness of 30 to 50 μm by hand. Electrochemical measurements are carried out on an EG&G potentiostat/galvanostat Model 2273 instrument. In a three-electrode system, the cell is equipped with aerogel monolith or GP attached to a platinum mesh network as working electrode, a platinum plate as counter electrode and a saturated calomel electrode (SCE) as a reference electrode, using 1M H₂SO₄ as aqueous electrolyte. In the case of ASSSs, two slices of aerogel monoliths or GPs are glued with a platinum wire by conducting silver paste each other, and thus are immersed in the hot solution of PVAH₂SO₄ gel electrolyte for 5 min and picked out. After that, the electrolyte-filled electrodes are solidified for 12 h at room temperature. Finally, the two as-prepared electrodes are symmetrically integrated into one ASSS under a pressure of about 5 MPa for 5 min.

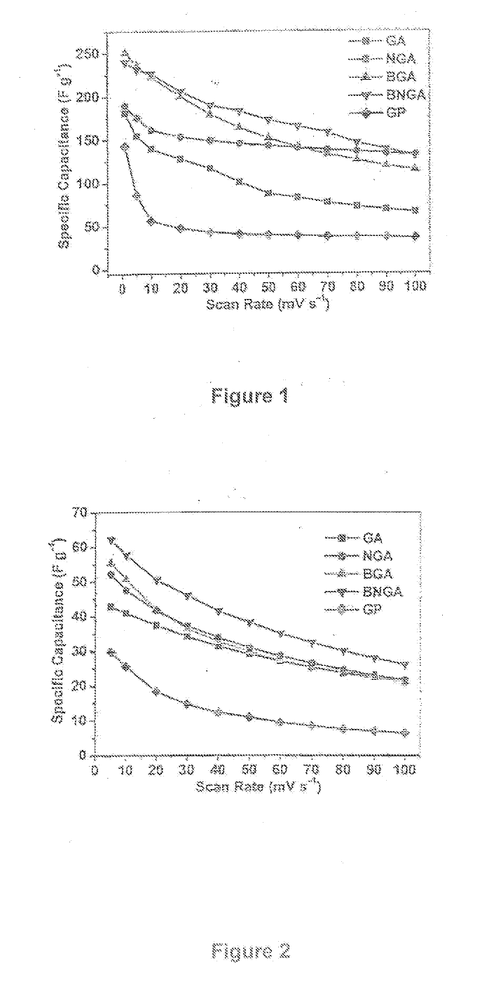

FIG. 1 shows a comparison of electrochemical performance of GA, NGA, BGA, BNGA and GP electrodes. The specific capacitance of said electrodes is shown as a function of scan rate. A strong synergetic effect of N- and B-doping can be seen for the BN GA electrode.

FIG. 2 shows the comparison of electrochemical performance of ASSSs based on GA, NGA, BGA, BNGA and GP. The specific capacitance of GA, NGA, BGA, BNGA, and GP based ASSSs based on two-electrode mass as a function of scan rates from 1 to 100 mV s⁻¹. The capacitance obtained for BNGA based ASSSs is much higher than these of GA, NGA, BGA and GP. This means that ASSSs based on BNGA displays a substantial improvement of specific capacitance at the varying scan rate from 5 to 100 mV s⁻¹ compared with NGA and BGA, indicating a higher rate capability for BNGA based device. This enhancement for BNGA based ASSSs was due to the synergistic effect of N- and B- co-doping on GAs, which can further improve electrochemical reversibility and occurrence of pseudocapacitance.

1. An aerogel comprising graphene doped with nitrogen and boron.

2. The aerogel according to claim 1, wherein the aerogel comprises from 0.1 to 6 wt. % of nitrogen and/or from 0.1 to 2 wt. % of boron.

3. The aerogel according to claim 1, wherein the aerogel further comprises Fe and/or Co and optionally at least one metal selected from the group consisting of Pt, Mn, Ni, V, Cr, Ti, Pd, Ru, Se and Cu.

4. The aerogel according to claim 3, wherein Fe is in the form of Fe, Fe₂O₃ or Fe₃O₄ and/or Co is in the form of Co, Co(OH)₂, Co₃O₄ or CoO.

5. The aerogel according to claim 3, wherein Fe, Co and/or any optionally present metal are in the form of small particles.

6. The aerogel according to claim 1, wherein the aerogel further comprises at least one metal selected from the group consisting of Pt, Mn, Ni, V, Cr, Ti, Pd, Ru, Se and Cu and optionally comprises Fe and/or Co.

7. A method for producing an aerogel according to claim 1, said method comprising to 6, wherein
i) treating graphene oxide with at least one component (A) comprising nitrogen and at least one component (B) comprising boron, or
ii) treating graphene oxide with at least one component (C) comprising both nitrogen and boron thereby obtaining graphene doped with nitrogen and boron.

8. The method according to claim 7, wherein treating graphene oxide further comprises a hydrothermal and/or a drying process.

9. The method according to claim 7, wherein graphite, is oxidized into graphite oxide, and the graphite oxide is delaminated into graphene oxide.

10. The method according to claim 7, wherein the component (A) is cyanamide (CH₂N₂), dicyandiamide (C₂H₄N₄), or ethylenediamine (C₂H₈N₂), the component (B) is boric acid (H₃BO₃) and the component (C) is NH₃BF₃ or NH₃BH₃.

11. An electrode comprising the aerogel from claim 1.

12. The electrode according to claim 11 further comprising an electrolyte.

13. The electrode according to claim 11, wherein said electrode is obtained by cutting the aerogel into slices with a thickness of 0.5 to 1.5 mm and/or having a diameter of 5 to 15 mm.

14. An all solid state supercapacitor (ASSS) comprising the aerogel according to claim 1.

15. A catalyst comprising the aerogel according to claim 1.

16. The catalyst according to claim 15, wherein said catalysts comprises small particles of Fe and Co.

17. (canceled)

18. (canceled)

19. A graphene doped with nitrogen and boron further contains further comprising Fe and/or Co and optionally at least one metal selected from the group consisting of Pt, Mn, Ni, V, Cr Ti, Pd, Ru, Se or Cu.

20. The graphene according to claim 19 further comprising at least one metal selected from the group consisting of Pt, Mn, Ni, V, Cr, Ti, Pd, Ru, Se or Cu and optionally comprises Fe and/or Co.

21. The graphene according to claim 19, wherein the graphene comprises from 0.1 to 6 wt. % of nitrogen and/or from 0.1 to 2 wt. %, of boron.

22. (canceled)

23. The aerogel according to claim 2, wherein the aerogel comprises from 2.5 to 3.5 wt. % of nitrogen and/or from 0.3 to 0.9 wt. % of boron.

24. The aerogel according to claim 5, wherein the small particles are nanoparticles.

25. The method according to claim 8, wherein the drying process is a freeze drying process.

26. The method according to claim 9, wherein the graphite is in the form of graphite flakes.

27. The electrode according to claim 12 wherein the electrolyte is selected from the group consisting of a PVAH₂SO₄ gel, a PVAH₃PO₄ gel, a PVAKOH gel, a PVA/NaOH gel, a PVA/Na₂SO₄ gel and a ionic liquid polymer gel.

28. An all solid state supercapacitor (ASSS) comprising the electrode according to claim 11.

29. The catalyst according to claim 16, wherein the small particles of Fe and Co are nanoparticles of Fe₃O₄ and CO₃O₄.

30. The graphene according to claim 21, wherein the graphene comprises from 2.5 to 3.5 wt. % of nitrogen and/or from 0.3 to 0.9 wt. % of boron.
